(19) United States
(12) Patent Application Publication
(10) Pub. No.: US 2014/0076995 A1
(43) Pub. Date: Mar. 20, 2014

(54) VAPOR CHAMBER AND METHOD OF MANUFACTURING THE SAME

(71) Applicant: Chin-Wen WANG, Pingzhen City (TW)

(72) Inventor: Chin-Wen WANG, Pingzhen City (TW)

(73) Assignees: Chin-Wen Wang; William Chiu; Chein-Hsuan Lee; Tzu Wang

(21) Appl. No.: 13/620,662

(22) Filed: Sep. 14, 2012

(51) Int. Cl. A01G 27/00; B23P 11/00

(52) U.S. Cl. 239/145; 137/15.01

(57) ABSTRACT

A vapor chamber and method of manufacturing the same are disclosed. The vapor chamber includes a lower shell, an upper shell, a wick structure and a working fluid. The lower shell has a bottom plate and a lower side plate extended from a periphery of the bottom plate. The upper shell has a top plate, an annular slot formed on the outer edge of the top plate, and an upper side plate extended from a periphery of the annular slot. The upper shell covers the lower shell so that the upper side plate abuts against the lower side plate, and a solder accommodating space is formed between the annular slot and the lower side plate.

### BACKGROUND OF THE INVENTION

1. Field of the Invention

The present invention generally relates to a vapor chamber and method of manufacturing the same, in particular to a vapor chamber with a solder accommodating space and method of manufacturing the same.

2. Description of Prior Art

As progress continues to be made in technology and compactness to be required of electronic productions, many kinds of vapor chambers are developed to dissipate heat for heating electronic components.

Currently, a vapor chamber is made by coupling a lower shell and an upper shell, and then the periphery of the lower shell and the upper shell will be aligned and pressed. Finally, the pressed periphery is sealed with solder.

However, the vapor chamber made in this way has some disadvantages as following. Firstly, the periphery of the vapor chamber will form a flange produced from soldering. The periphery of the vapor chamber is not in a flat state and the appearance or looks thereof is not good. Secondly, the solder is weld circularity on the junction edges of the lower shell and the upper shell. Therefore, the solder tends to be dropped on the working table easily in welding process, and the working environment will become dirty. Thirdly, the solder of suspended welding is easily peeled off after soldering, and the sealing effect is reduced.

In view of the above drawbacks, the Inventor proposes the present invention based on his expert knowledge and elaborate researches in order to solve the problems of prior art.

### SUMMARY OF THE INVENTION

Accordingly, an object of the present invention is to provide a vapor chamber which the solder will not drop around the periphery of vapor chamber while welding, and the solder will not peeled off easily after welding.

In order to achieve the object mentioned above, the present invention provides a vapor chamber includes a lower shell, an upper shell, a wick structure, and a working fluid. The lower shell has a bottom plate and a lower side plate extended from the periphery of the bottom plate. The upper shell has a top plate, an annular slot formed on the outer edge of the top plate, and an upper side plate extended from the periphery of the annular slot. The upper shell covers the lower shell so that he upper side plate abutting against the lower side plate, and a solder accommodating space is formed between the annular slot and the lower side plate.

Another object of the present invention is to provide a method of manufacturing the vapor chamber. The solder of the vapor chamber will not drop around the periphery of vapor chamber while welding, and the solder will not peel off easily after welding.

In order to achieve the object mentioned above, the present invention provides a method of manufacturing vapor chamber. The method includes the following steps: (a) forming a lower shell having a bottom plate and a lower side plate extended from the periphery of the bottom plate, and a capillary wick is sintered on an upward surface of the bottom; (b) forming an upper shell having a top plate, an annular slot formed on the outer edge of the top plate and an upper side plate extended from the periphery of the annular slot, and another wick structure sintered on the inner wall of the upper shell; (c) filling a working fluid into the interior of the lower shell; (d) covering the upper shell on the lower shell so that the upper side plate abutting against the lower side plate, and a solder accommodating space formed between the annular slot and the lower side plate; (e) soldering the solder in the solder accommodating space for sealing the upper shell and the lower shell; (f) evacuating the space between the lower shell and the upper shell through a degassing tube; and (g) sealing the degassing tube.

Comparing to the prior art, the present invention has the following effects. The vapor chamber of the present invention has a lower shell and an upper shell, and an annular slot formed on the periphery of the top plate of the upper shell. When the upper shell covers on the lower shell, a solder accommodating space is formed between the annular slot of the upper shell and the lower side plate of the lower shell. By this constitution, the solder is dropped in the solder accommodating space from the upper shell above when the upper shell is welded with the lower shell. Therefore, the solder will not drop around the vapor chamber on the working table. The working environment of the production line will be kept clean.

Besides, because the solder after cooling is received in the solder accommodating space firmly and supported by the lower side plate of the lower shell, the solder can be avoided from being peeled off and the welding strength and the sealing effect of the vapor chamber will be maintained.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is an exploded perspective view according to the present invention;

FIG. 2 is an assembled perspective view of the present invention;

FIG. 3 is an assembled cross section view according to the present invention;

FIG. 4 is a partial enlarged view of the part A of the FIG. 3, wherein the solder is not filled in the solder accommodating space;

FIG. 5 is another partial enlarged view of the part A of the FIG. 3, wherein the solder is already filled in the solder accommodating space; and

FIG. 6 is an assembled perspective view of the present invention, wherein the degassing and sealing steps are accomplished.

FIG. 7 is an assembled perspective view of the present invention of another embodiment.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

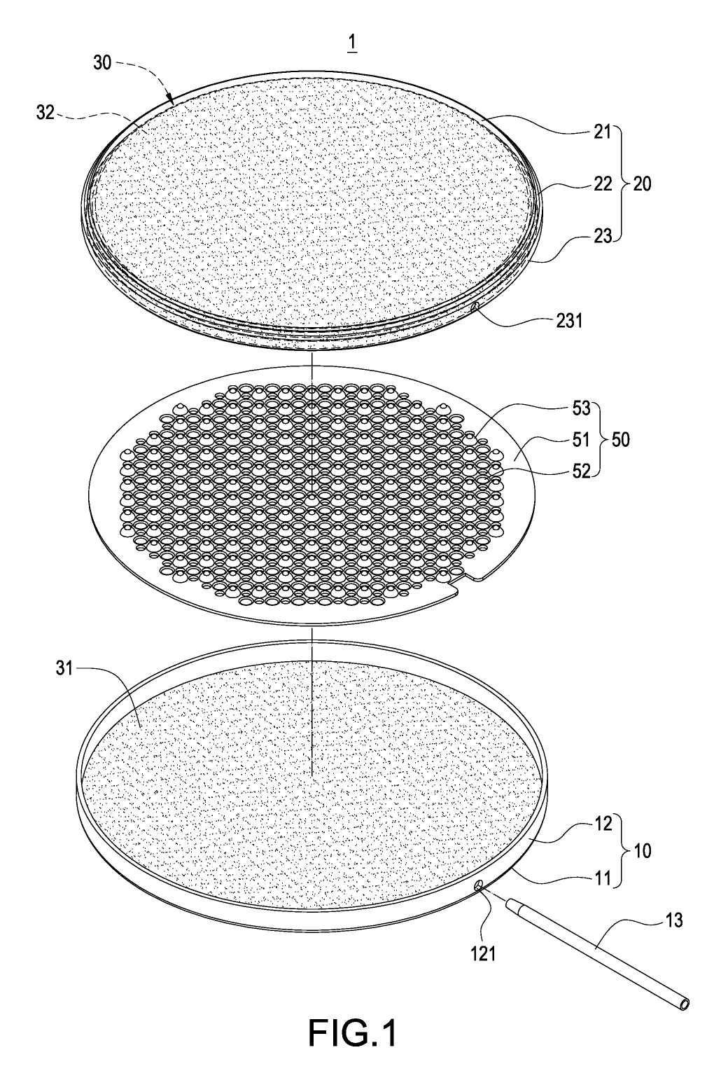

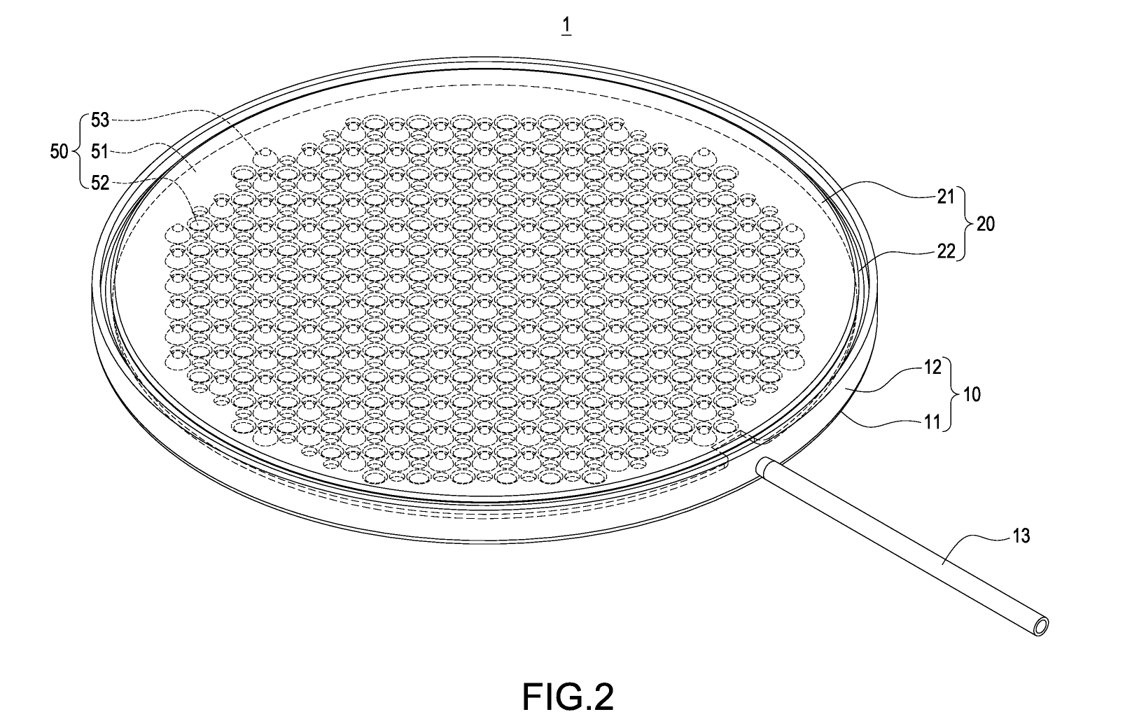

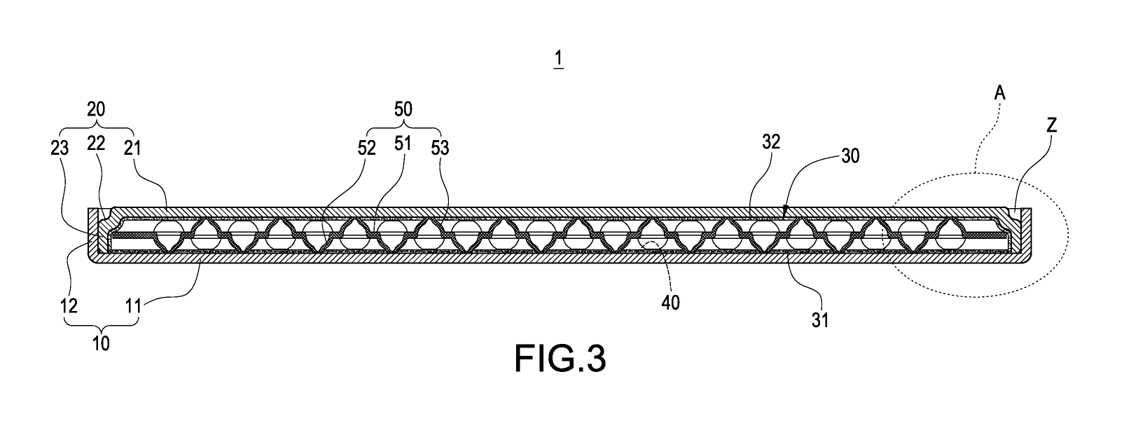

Please refer to FIG. 1 to FIG. 5, the invention provides a vapor chamber and method of manufacturing the same. The vapor chamber 1 of the present invention includes a lower shell 10, an upper shell 20, a wick structure 30, a working fluid 40, and a supporting structure 50.

The lower shell 10 is in a disc shape generally, and it can be made of metal or ceramic material. The lower shell 10 has a bottom plate 11 and a lower side plate 12 extended from the periphery of the bottom plate 11. The lower side plate 12 has a degassing hole 121 for penetrating a degassing tube 13. Beside, a lower capillary wick 31 is sintered on one upper surface of the bottom plate 11.

Similarly, the upper shell 20 is in a disc shape generally, and it can be made of metal or ceramic material. The lower shell 20 has a top plate 21, an annular slot 22 formed from the outer edge of the top plate 21, and a top side plate 23 extended from the periphery of the annular slot 22. The top plate 23 has a through hole 231 for penetrating the degassing tube 13.

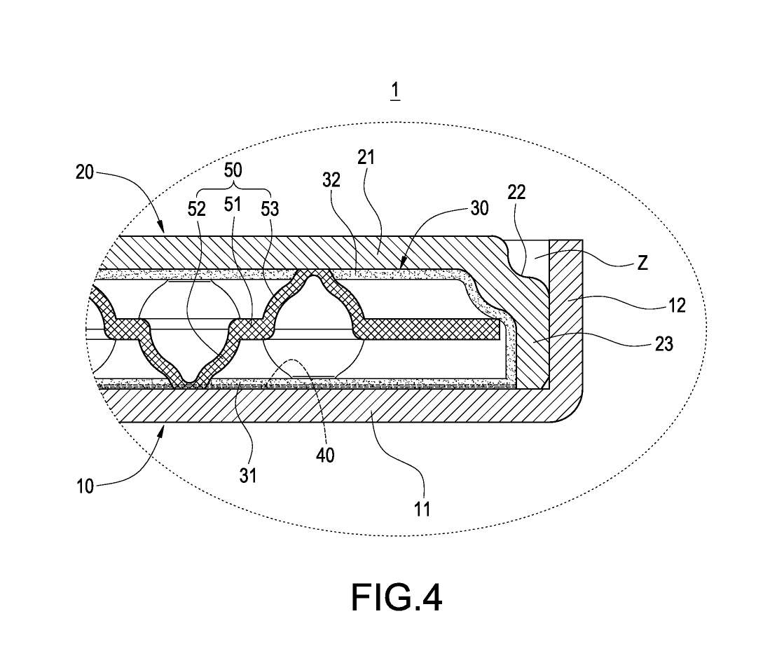

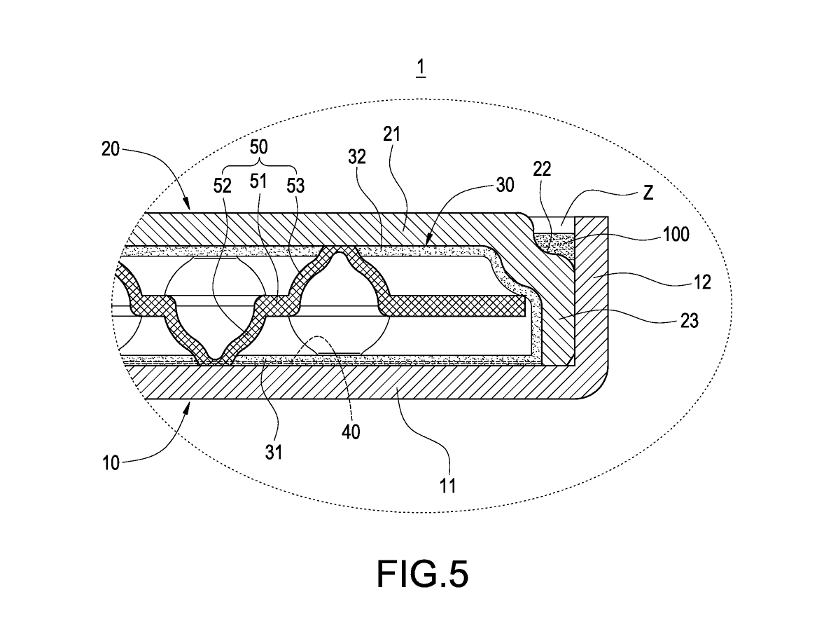

From the comparison between FIG. 4 and FIG. 5, the outer diameter of the upper shell 20 is smaller than that of the inner diameter of the lower shell 10. When the upper shell 20 covers the lower shell 10, the upper side plate 23 will abut against the lower side plate 12, and a solder accommodating space Z is formed between the annular slot 22 and the lower side plate 12. Moreover, horizontal height of the upper edge of lower side plate 12 is higher than that of the annular slot 22 and is substantially in the same level with the top plate 21. As a result, the solder 100 can be stored in the solder accommodating space Z as shown in the FIG. 5, and the lower side plate 12 can block the solder 100 from being dripped or peeled off in the meanwhile. In the FIG. 5, the upper edge of the lower side plate 12 can be bent toward the annular slot 22 for covering the solder 100, and a chamfer will be formed on the periphery of the vapor chamber 1.

Furthermore, an upper capillary wick 32 is sintered on the inner wall of the upper shell 20. The lower capillary wick 31 of the lower shell 10 and the upper capillary wick 32 of the upper shell 20 constitute the wick structure 30 of the present invention. The working fluid 40, such as water, is filled between the lower shell 10 and the upper shell 20. The heat is conducted to the top plate 21 of the upper shell 20 through the phase change of the working fluid 40 and the circulation between the lower capillary wick 31 and the upper capillary wick 32. As the working principle of the vapor chamber is known knowledge and is not technical feature of the present invention, the more detailed description is omitted here for brevity.

As shown in FIG. 1, a supporting structure 50 is disposed between the lower shell 10 and the upper shell 20 for supporting the bottom plate 11 of the lower shell 10 and the top plate 21 of the upper shell 20. Hence, depress of the bottom plate 11 and the top plate 21 of the vapor chamber 1 (which is caused by outside air pressure and external force) can be avoided. The support structure 50 includes a board 51 and a plurality of raising supports 52,53 protruded from the two surfaces of the board 51. Those raising supports 52,53 abut against the bottom plate 11 of the lower shell 10 and the top plate 21 of the upper shell 20 respectively. Thus the structural strength of the whole vapor chamber 1 will be enhanced.

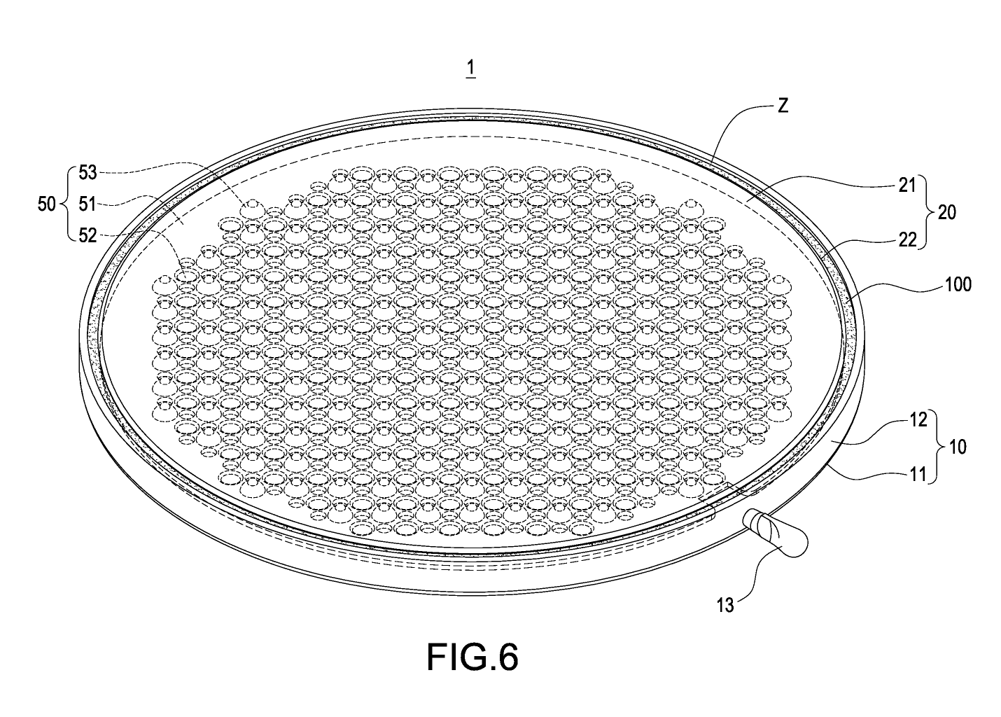

With referring to FIG. 6, after the vapor chamber 1 of the present invent is assembled and welded, the internal of the vapor chamber 1 is evacuated through the degassing tube 13. Finally, a section of the degassing tube 13 exposed outside will be welded or pressed, and the sealing will be achieved.

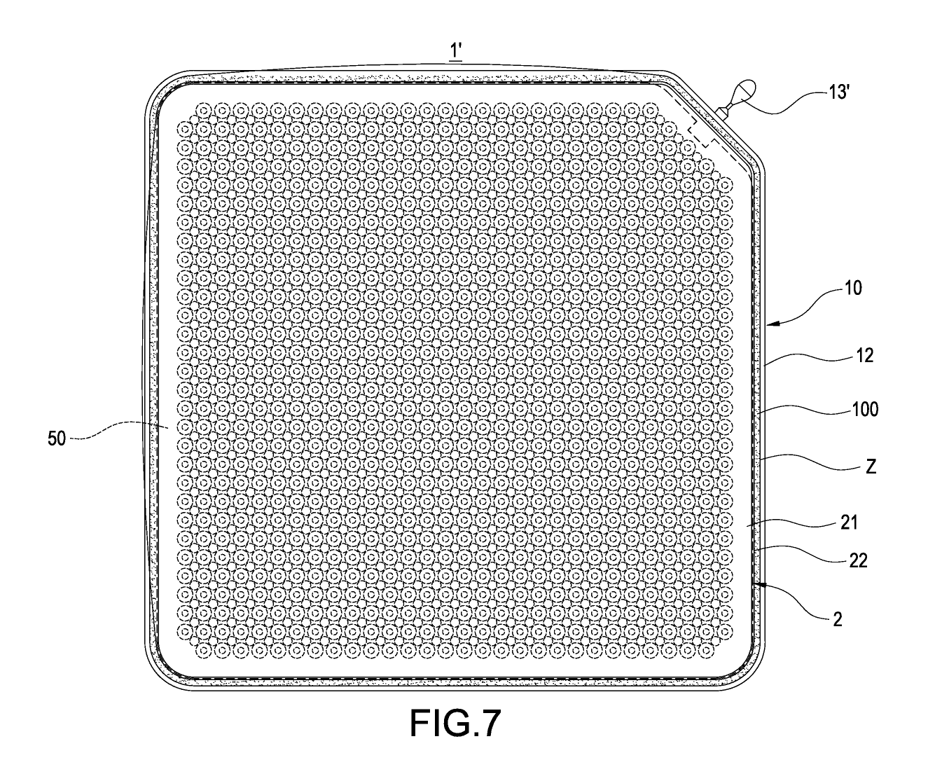

Please refer to FIG. 7, another embodiment of the present is shown. A difference between this embodiment and the first embodiment is the vapor chamber shape. The vapor chamber 1 of the first embodiment is in a disc shape, and this embodiment of the present invention is in a square shape. Besides, the degassing tube 13′ located at one corner is another difference. In spite that the shapes of the lower shell 10 and the upper shell 20 of the vapor chamber 1′ are changed to a square shape, an annular slot 22′ is disposed on the periphery of the upper shell 20 still. Moreover, a solder accommodating space Z is formed by enclosing the upper shell 20 and the lower side plate 12 of the lower shell 10 for receiving the solder 100.

A method of manufacturing the vapor chamber of the present invention includes the following steps:

(a) forming a lower shell 10 having a bottom plate 11 and a lower side plate 12 extended from the periphery of the bottom plate 12, and a wick structure (lower capillary wick 31) sintered on a surface of the bottom 11 upward;

(b) forming an upper shell 20 having a top plate 21, an annular slot 22 formed on the outer edge of the top plate 21, an upper side plate 23 extended from the periphery of the annular slot 22, and another wick structure (upper capillary wick 32) sintered on the inner wall of the upper shell 20;

(c) filling a working fluid, such as water, into the interior of the lower shell 10;

(d) covering the upper shell 20 on the lower shell 10 so that the upper side plate 23 will abut against the lower side plate 12, and a solder accommodating space Z is formed between the annular slot 22 and the lower side plate 12;

(e) soldering the solder 100 in the solder accommodating space Z for sealing the upper shell 20 and the lower shell 10;

(f) evacuating the space between the lower shell 10 and the upper shell 20 through a degassing tube 13; and

(g) sealing the degassing tube 13.

Moreover, a step (b′) is optionally added between the step (b) and the step (c). The step (b) is to dispose a support structure 50 between the lower shell 10 and the upper shell 20. As illustrated in FIG. 1, the supporting structure 50 is used for supporting the bottom plate 11 of the lower shell 10 and the top plate 21 of the upper shell 20 therebetween. Hence, depressing of the bottom plate 11 and the top plate 21 of the vapor chamber 1 (which is caused by outside air pressure and external force) can be avoided. The support structure 50 includes a board 51 and a plurality of raising supports 52,53 protruded from two surfaces of the board 51. The raising supports 52,53 abut against the bottom plate 11 of the lower shell 10 and the top plate 21 of the upper shell 20 correspondingly. Thus the structural strength of the whole vapor chamber 1 will be enhanced.

Comparing to the prior art, the present invention has the following effects. The vapor chamber 1 of the present invention has a lower shell 10 and an upper shell 20, and an annular slot 22 is formed on the periphery of the top plate 21 of the upper shell 20. When the upper shell 20 covers the lower shell 10, a solder accommodating space Z is formed by enclosing the annular slot 22 of the upper shell 20 and the lower side plate 12 of the lower shell 10. By this constitution, the solder 100 is dropped in the solder accommodating space Z from the upper shell 20 above when the upper shell 20 is welded with the lower shell 10. Therefore, the solder 100 will not drop around the vapor chamber 1 on the working table. The working environment of the production line will be kept clean.

Besides, because the solder 100 after cooling is received in the solder accommodating space Z firmly and supported by the lower side plate 12 of the lower shell 10, the solder 100 can be avoided from being peeled off and the welding strength and the sealing effect of the vapor chamber 1 will be maintained.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A vapor chamber, comprising:
a lower shell having a bottom plate and a lower side plate extended from a periphery of the bottom plate;
an upper shell having a top plate, an annular slot formed on the outer edge of the top plate, and an upper side plate extended from a periphery of the annular slot, the upper shell covering the lower shell so that the upper side plate abuts against the lower side plate, and a solder accommodating space is formed between the annular slot and the lower side plate;
a wick structure disposed on the inner wall of the bottom plate and the upper shell; and
a working fluid filled between the lower shell and the upper shell.

2. The vapor chamber according to claim 1, wherein the upper edge of the lower side plate is higher than that of the annular slot, and solder in the solder accommodating space can be held.

3. The vapor chamber according to claim 2, wherein the lower side plate has a degassing hole for penetrating a degassing tube, the upper side plate has a through hole placed corresponding to the degassing hole for penetrating the degassing tube.

4. The vapor chamber according to claim 2, wherein the wick structure includes a lower capillary wick disposed on the bottom plate and a upper capillary wick disposed on the inner wall of the upper shell.

5. The vapor chamber according to claim 4, further include a supporting structure disposing between the bottom plate and the top plate.

6. The vapor chamber according to claim 5, wherein the supporting structure includes a board and a plurality of raising supports protruded from the two surfaces of the board, those raising supports abut against the bottom plate and the top plate respectively.

7. The vapor chamber according to claim 1, wherein the upper edge of the lower side plate is bent toward the annular slot for covering solder in the solder accommodating space.

8. The vapor chamber according to claim 7, wherein the lower side plate has a degassing hole for penetrating a degassing tube, and the upper side plate has a through hole placed corresponding to the degassing hole for penetrating the degassing tube.

9. The vapor chamber according to claim 7, wherein the wick structures includes a lower capillary wick disposed on the bottom plate and an upper capillary wick disposed on the inner wall of the upper shell.

10. The vapor chamber according to claim 9, further including a supporting structure disposed between the bottom plate and the top plate.

11. The vapor chamber according to claim 10, wherein the supporting structure includes a board and a plurality of raising supports protruded from two surfaces of the board, those raising supports abut against the bottom plate and the top plate correspondingly.

12. A method of manufacturing vapor chamber, comprising
(a) forming a lower shell having a bottom plate and a lower side plate extended from the periphery of the bottom plate, and a capillary wick is sintered on a upward surface of the bottom;
(b) forming an upper shell having a top plate, an annular slot formed on the outer edge of the top plate and an upper side plate extended from the periphery of the annular slot, and another wick structure sintered on the inner wall of the upper shell;
(c) filling a working fluid into the interior of the lower shell;
(d) covering the upper shell on the lower shell so that the upper side plate abuts against the lower side plate, and a solder accommodating space formed between the annular slot and the lower side plate;
(e) soldering the solder in the solder accommodating space for sealing the upper shell and the lower shell;
(f) evacuating the space between the lower shell and the upper shell through a degassing tube; and
(g) sealing the degassing tube.

13. The method according to claim 12, wherein a step (b′) is added between the step (b) and the step (c): disposing a support structure between the lower shell and the upper shell.

14. The method according to claim 13, wherein the support structure includes a board and a plurality of raising supports protruded from the two surfaces of the board, and the raising supports abut against the bottom plate and the top plate respectively.
